(19) United States
(12) Patent Application Publication
(10) Pub. No.: US 2003/0128991 A1
(43) Pub. Date: Jul. 10, 2003

(54) Integrated service data management system

(75) Inventors: Richard R.T. Carling, Lakeville, NY (US); Thomas L. Schwartz, Fairport, NY (US); Robin K. Braden, Rochester, NY (US)

Correspondence Address: Lawrence P. Kessler, Patent Department, NexPress Solutions LLC, 1447 St. Paul Street, Rochester, NY, 14653-7103, US

(73) Assignee: NexPress Solutions LLC

(21) Appl. No.: 10/166,493

(22) Filed: Jun. 10, 2002

Related U.S. Application Data
(60) Provisional application No. 60/345,435, filed on Jan. 4, 2002.

(51) Int. Cl. G03G 15/00

(52) U.S. Cl. 399/8; 702/182; 707/104.1

(57) ABSTRACT

Message logs are created on serviceable pieces of equipment and transmitted to a centralized site where they are uploaded and inserted into a centralized database. Preferably, a digital printer that maintains message logs reporting printer page counts, jobs run, errors encountered, component replacement, maintenance performed, status and diagnostic information. Reports are created from log data from the machines in the field and are accessible from a Web Server for numerous systems. The reports can predict demand on component parts to assist in maintaining adequate inventories, provide research and development teams with insight into functions and capabilities that may be advantageous to add to new machines in the future, or report information back to the individual customer as a value-added service.

### CROSS-REFERENCE TO RELATED APPLICATIONS

This application claims priority of the U.S. Provisional Application Serial No. 60/345,435, entitled, INTEGRATED SERVICE DATA MANAGEMENT SYSTEM, filed Jan. 4, 2002.

This application is related to the following applications which are hereby incorporated by reference:

1. U.S. patent application Ser. No. 10/011,331 filed in the names of Thomas L. Schwartz, et al., and entitled, OPERATOR REPLACEABLE COMPONENT LIFE TRACKING SYSTEM, filed on Nov. 5, 2001.

2. U.S. patent application Ser. No. 10/008,283, filed in the names of Richard R. T. Carling, et al., and entitled, PERSONALIZATION OF OPERATOR REPLACABLE COMPONENT LIFE PREDICTION BASED ON REPLACEABLE COMPONENET LIFE HISTORY, filed on Nov. 5, 2001.

3. U.S. patent application Ser. No. 10/028,000, filed in the names of Thomas L. Schwartz, et al., entitled, LINKING ORC LIFE TRACKING/USAGE WITH INVENTORY MANAGEMENT, filed on Dec. 20, 2001.

4. U.S. patent application Ser. No. 10/028,134, filed in the names of Thomas L. Schwartz, et al., entitled, ORC ONLINE INVENTORY MANAGEMENT SYSTEM, filed on Dec. 20, 2001.

### FIELD OF THE INVENTION

The present invention relates to data collection and more particularly, to filtering and integrating data that is collected over a diverse environment.

### BACKGROUND OF THE INVENTION

The concept of logging information has been applied repeatedly to various types of products and numerous systems. Prior art systems within the field of information logging have provided a service engineer with the ability to generate a service report containing data specific to printer-based products after maintenance has been performed. The service report typically contains information that is recorded by a service engineer while servicing a piece of equipment. These service reports conventionally, can be hand written, verbally transferred telephonically and manually transcribed at the receiving end, or created electronically on a laptop computer and transported with the laptop to a central site for upload and analysis and consolidation.

Other prior art data accumulation techniques for printing systems allow the logs to be extracted off the machine by the field engineer and hand carried back to a central site for analysis. Still other prior art systems allow remote extraction of specific system data remotely from a central site to perform remote diagnostics and collect data, or simply monitor remotely.

There are prior art systems that will automatically initiate a service call to a centralized site when a lockout situation is encountered on a machine. However, these systems lack in that they do not provide for a centralized accumulation of data for various machines.

A problem that exists within the above discussed prior art systems for accumulating and logging data, is the lack of a fully automated solution that provides the ability to collect data from distributed systems by a central location that can perform an analysis in a predetermined manner.

### SUMMARY OF THE INVENTION

The present invention addresses the problems within the prior art by providing a Service Data Management System (SDMS) that is an integrated system that can collect and analyze data from numerous pieces of serviceable equipment at a central location.

These and other features are provided by the present invention providing a system for integrating information related to equipment operation comprising; at least one piece of equipment located at least at a first location, a data repository at a second location remote from the first location, an interface between the piece of equipment and the data repository that allows data from the piece of equipment to be collected and stored at the data repository, and a filtering mechanism for applying at least one predetermined parameter to data on the interface to create a filtered data set, in which the filtered data set represents data collected from the machines for at least service history and types of use of the machines.

### BRIEF DESCRIPTION OF THE DRAWINGS

FIG. 1a is an illustration of the preferred architecture for utilizing the Internet to transfer information from digital printers;

FIG. 1b is an illustration of a NexPress® 2100;

FIG. 2 is an illustration of a pop up screen used to configure data transmission within the preferred embodiment;

FIG. 3 is an illustration of a pop up screen used to configure filter content;

FIG. 4 is an illustration of a pop up screen used to configure a service call;

FIG. 5 is an illustration of a pop up screen used to capture a service call report;

FIG. 6 is an illustration of a pop up screen used to view service call history;

FIG. 7 is an illustration of a pie chart used to show various SDMS and NexPert™ functions;

FIG. 8 is a high level diagram illustrating the capture, storing and reporting of information by SDMS;

FIG. 9 is an illustration of SDMS data flow; and

FIG. 10 is an illustration of the repository architecture employed by the preferred embodiment.

### DETAILED DESCRIPTION OF THE INVENTION

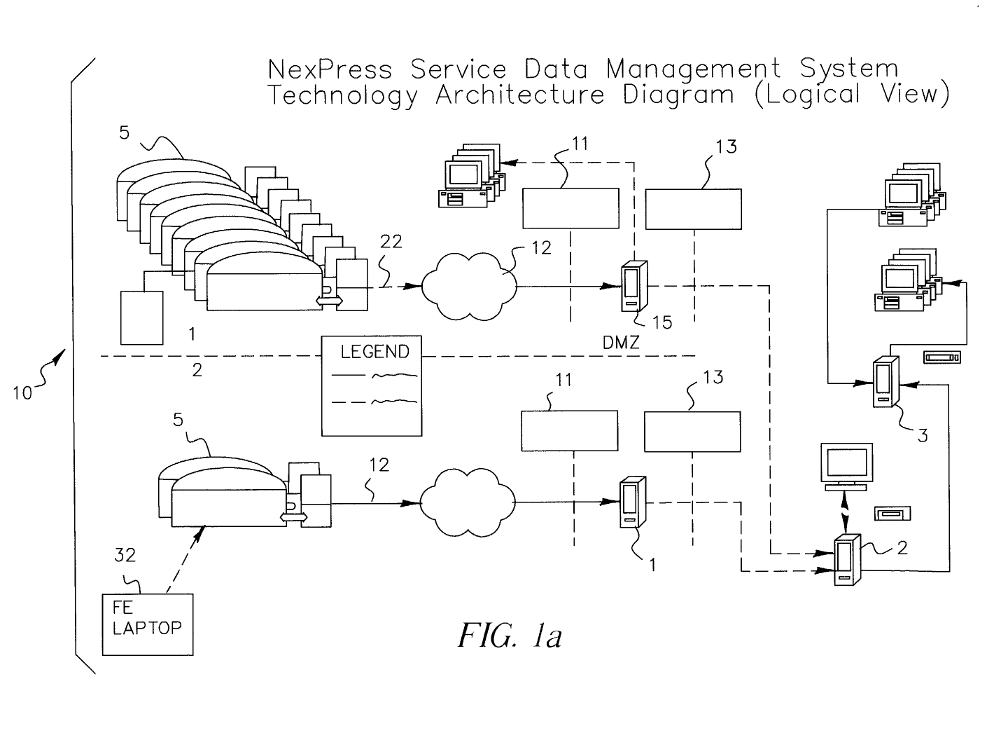

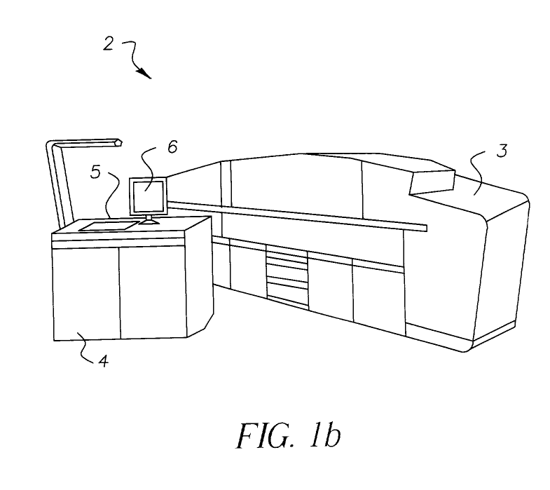

The present invention provides an integrated system capable of collecting and analyzing data from serviceable pieces of equipment at various locations. The preferred embodiment of the system of the present invention is the Service Data Management System (SDMS), generally referred to as 10, as shown in FIG. 1a. The preferred embodiment employs as the serviceable pieces of equipment, digital printers 5, specifically the NexPress® 2100 is employed as printer 5. A NexPress® 2100 is used by the preferred embodiment because the NexPress® 2100 incorporates numerous features that allow an operator to perform on site maintenance. More specifically, the NexPress® 2100 is a digital printing device that provides a printer message log within a database management system located internally within the printer 5. The message log maintains a database for information regarding the printer 5 such as error messages, diagnostic and service messages to be maintained within the printer 5. These messages provide the ability to track printer page counts, job run histories, errors encountered, and records components that have been replaced. Additionally, the NexPress® 2100 provides a message log that can keep records of the status of serviceable parts (including electrophotographic parts) within printer 5, the log of tracked information can additionally include the number of sheets and the types of paper that have been printed on by the printing system, as well as providing diagnostic and technical data related to the parts, referred to herein as trend data for the printer 5.

The preferred embodiment of the invention uses as printer 5, the NexPress® 2100 digital printer because of the inherent support for the creation and tracking of field engineer service reports via components for the SDMS 10 that are provided within computational elements contained within the NexPress® 2100. The Digital Front End (DFE) is a computational element within in the NexPress® 2100 that is used to maintain a log of the operator replaceable components for the SDMS 10, however, it will be understood by those skilled in the art that other computational components could be used and within the NexPress® 2100. There are multiple processing elements within the NexPress® 2100 that can perform SDMS 10 related tasks individually or in a distributed processing mode to maintain a database of logs data. The NexPress® 2100 also provides the SDMS 10 with the capability to extract the logs data and Field Engineer Service Reports from the DFE database, converts them into machine readable content in the form of an Extensible Markup Language (XML) logs data and sends the XML logs data files to a central site. Preferably, the XML log data files are sent to the central site on a regular basis that is time programmable. The time basis by which the XML logs data files are sent to the central site can be configured by the operator to be virtually any desired time period, such as hourly, daily or weekly. It will be understood by those skilled in the art that the basis of transmitting the XML logs data files Field Engineer Service Reports can be on a basis other than a regular time basis, such as by querying the DFE or having an operator send the XML logs data files on demand. It will also be understood that other software formats or different mark up languages other than XML can be used to send logs data files, call reports and Field Engineer Service Reports.

The overall purpose of the present invention is to continually update databases with data from printers 5 to provide constant analysis of data related to specific use of printers 5 at a particular site as well as to provide continued insight into printers 5 across a broad spectrum of uses. Accordingly, the preferred embodiment envisions that the central site used to receive the integrated data from printers 5 at numerous locations should be an entity that has business relations with the owner/operators of printers 5 and is also extremely knowledgeable about the printers 5. Therefore, in the preferred embodiment, the XML logs data files from printers 5 are electronically sent to a data collection server 1 that is maintained at a central site remote from the printers 5 by either a supplier or manufacturer of the printers 5. The data collection server 1 is therefore maintained by a business entity higher in the supply chain of printers 5 than the owners/operators of printer 5. A business partner that is higher in the supply chain than the owner/operator of the printer 5 would typically be either the manufacturer of the equipment, or one of the business entities that is responsible for marketing the equipment. In the case of the preferred embodiment, the NexPress® 2100 digital printer is manufactured by NexPress Solutions, LLC and marketed by Heidelberg Digital. Accordingly, both NexPress Solutions, LLC and Heidelberg Digital would be business entities that are higher in the supply chain than the owner/operator a NexPress® 2100 used as printer 5 within the invention. The owner/operator of a NexPress® 2100 is typically a professional printer. Both NexPress Solutions, LLC and Heidelberg Digital are corporate partners that are higher in the supply chain than the owner/operator. Accordingly, NexPress Solutions, LLC and Heidelberg Digital will have specific knowledge and skills regarding the equipment that the owner/operator will not have. These business partners that are higher in the supply chain than the owner/operators of printers 5, are referred to herein as channel partners. Special knowledge and skills are held by the channel partners that are useful in analyzing data according to the specific use of a piece of equipment. FIG. 1 is a high level diagram that illustrates the data flow from printer 5 over an Internet based connection to a centralized site that is operated by a channel partner. At the centralized site, the XML logs data files are uploaded and inserted into a centralized database. In the preferred embodiment, reports are created off of the logs data reported from the printers 5 in the field and are accessible from a Web Server as PDF or HTML.

The SDMS 10 of the preferred embodiment also supports customer generated service reports at the call-reporting centers to allow creation and integration of customer generated service reports with field engineer service reports. By integrating customer generated service call reports with field service reports, the SDMS 10 of the invention provides service organizations with a uniform centralized reporting mechanism for all problems relating to a specific printer 5. The reports generated for SDMS 10 allows hourly status on all systems out in the field. The SDMS 10 reports essential information to a variety of groups supporting the printers 5. As an example, when a field engineer is needed to service a machine, he can obtain the machine's service reports and history log data to better understand the types of errors being encountered by the customer (owner/operator), the types of prior field service that has been performed as well as internal printer calibrations that the machine calculates daily (e.g. the EP calibration).

Channel partners are provided with reports relevant to Operator Replaceable Component (ORC) usage information to predict future ORC demand and maintain adequate local inventory levels. ORC average life calculations as well as new ORC estimation based on former ORC life cycles, and field engineer service reports for tracking service calls performed on the machines.

The business entity that is higher in the supply chain than the owner/operator, such as a principle manufacturing site, can use the service data reports to determine customer productiveness, hardware reliability, software reliability and machine utilization. Additionally, the present invention provides channel partners with the ability to determine needed corrective actions in process, manufacturing of workflow, predicted ORC revenue, predicted consumable revenue, Service Replaceable Component (SRC) manufacturing demand as well as consumables. Furthermore, the present invention provides data to a knowledgeable source so that a determination can be made of ORC and SRC reliability.

The invention integrates field engineer service reports and call-center service reports to maintain a complete history of the service calls and customer problems. The maintenance of these reports provides advanced research and development teams with insight into what functions and capabilities may be advantageous to be added to new machines in the future. These reports also provide individual printer information, or printer information for a particular site having potential multiple printers, back to the individual customers on a per-printer basis as a customer value-added service.

The SDMS as envisioned by the present invention encompasses several components. FIG. 1 presents two methods of information flowing from the NexPress® 2100 digital printers on the left. Communication constraints exist for some customers where dedicated Internet access may be prohibitively expensive or where the customer may prefer to filter and limit the amount and type of content provided back to the centralized site.

FIG. 1 illustrates the preferred architecture for utilizing the Internet to transfer information within the present invention. Data is transmitted from a NexPress® 2100 digital printer 5 to an external data collection server 15 via an Internet connection 12. The preferred embodiment of the SDMS 10 will typically have the external server 15 operated by a channel partner at a location that is remote from the NexPress® 2100 digital printer 5. In FIG. 1 the customer's NexPress® 2100 digital printer 5 will interface with the channel partner through an Internet connection 12. Typically, the NexPress® 2100 digital printer 5 is owned by a direct or indirect customer of a channel partner. Note, that while FIG. 1 shows the connection from the customer to the channel partner as an occasional connection, it should be understood that more permanent connections are equally envisioned. Customers can have direct, dedicated Internet connectivity and it is not necessary to modify the design to accommodate such a direct connection. If the customer chooses to use FTP to transfer data, they must assure that an Internet connection is present before starting the transfer. Customers who do not have a dedicated connection to the Internet would typically utilize email as their communication method.

The function of the data collection server 15 is to collect data from systems connected via the Internet connection 12, validate the data, filter the data if desired or needed, and transfer the data back to the SDMS data repository 2. In the preferred embodiment, the data collection server 1 will pass data through a channel firewall 11 that exists at the channel partner site where the data collection sever 1 is located. Information collected on the data collection server 1 is passed at frequent intervals to the SDMS data repository 2, and in the preferred embodiment the data from the data collection server 1 will pass through another channel firewall 13 before arriving at the SDMS data repository 2. It will be understood by those skilled in the art, that the connection to the Internet connection 12 does not have to be a dedicated connection and that these connections to the Internet connection 12 do not necessarily have to pass through firewalls.

It should be noted that interfaces can be configured differently from the preferred embodiment so that data from the printer 5 can flow directly to the channel partners. The interfaces can also be configured such that each channel partner receives that same data or filters can be applied at the firewalls such that the channel partners receive different sets of data. The interfaces can also be configured such that owner/operators select the actual data that is transmitted. The interfaces can be further configured such that owner/operators receive either the same data as the channel partners or a different set of data from the channel partners as well as having access to varying degrees of the SDMS data repository 2.

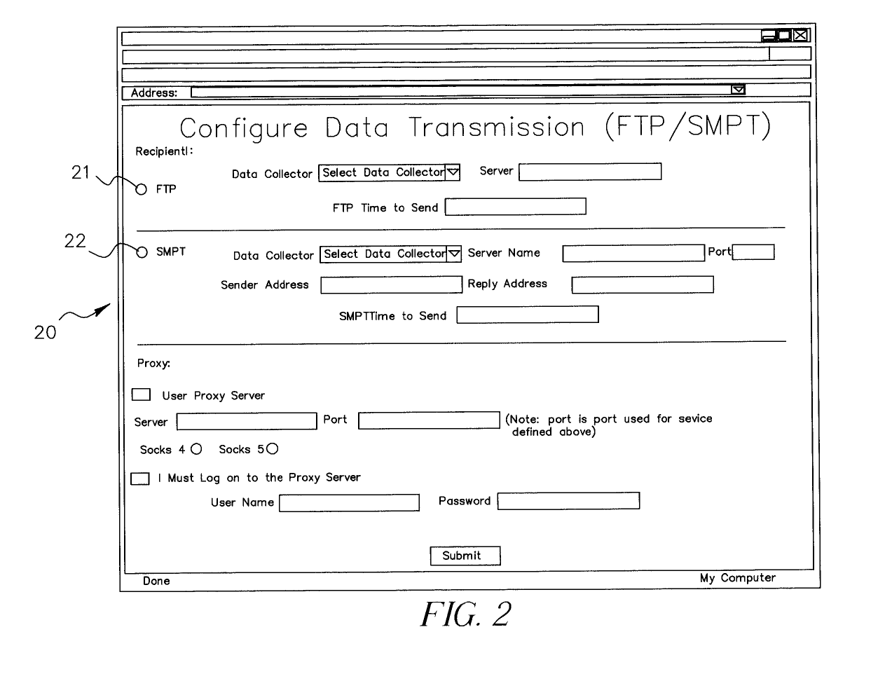

Referring to FIG. 2, an illustration of a pop up screen for configuring data transmission 50 from the printers 5 as employed by the preferred embodiment of the present invention is shown. The pop up screen for configuring data transmission 50 provides two transfer protocols, the first is File Transfer Protocol (FTP) 51 which provides more Internet access in comparison to Simple Mail Transfer Protocol (SMTP) 52 which provides email based transfer. The preferred embodiment employs FTP 51, although SMTP 52 can also be used. It should also be understood that numerous transfer protocols could be used in place of FTP 51 or SMTP 52.

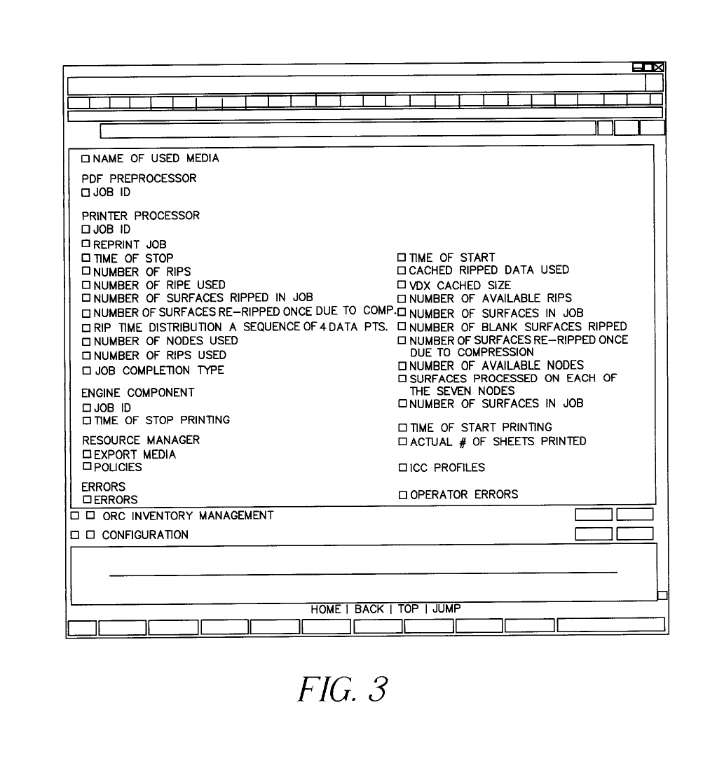

The filtering of data content is controlled by the pop up screen for configuring filtering content 60 illustrated in FIG. 3. The pop up screen for configuring filtering content 60 provides numerous options that allow the owner/operator to control the types of data that are sent to the data collection server 1.

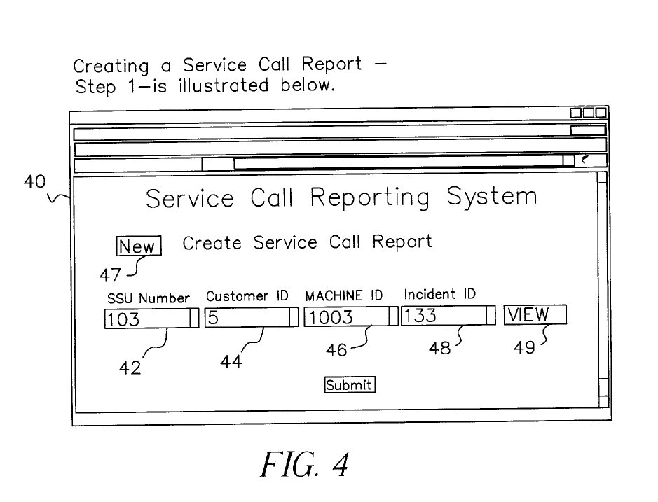

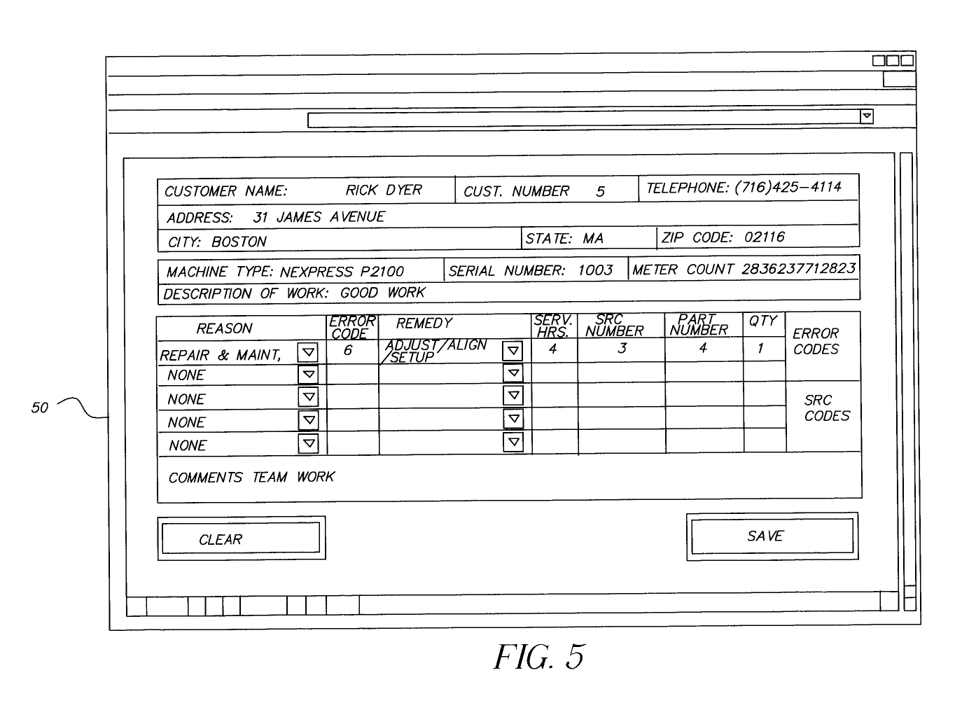

FIG. 4 is an illustration of the create a service call report pop up screen 40 which is displayed by the GUI 6 of printer 5 within the preferred embodiment. The display of the pop up screen for create a service call report 40 is initiated by operator selection of the URL bookmark for that pop up screen. The pop up screen illustrated in FIG. 4 represents the first step in the service call reporting system. Preferably, the URL will launch a web page that displays indicators for the Sales Service Unit (SSU) 42, Customer ID 44, Machine ID 46, Incident ID 48 as well as a view button 49 and a create service call Report button 47. The SSU 42 represents a specific service group or organization that is responsible for servicing that particular piece of equipment identified by the Machine ID 46. The Customer ID 44 identifies the owner/operator (typically a printer in the case of the preferred embodiment) that owns or operates the printer 5 that is identified by the Machine ID 46. Incident ID 48 references a specific service related for the printer 5 identified by Machine ID 46. The actual number that is contained within the Incident ID 48 is provided by the call center dispatcher when a service call is first initiated. The call center dispatcher is envisioned as being a person associated with the service organization identified by SSU 42. View button 49 allows the operator to move from the create service call pop up screen 40 to a detailed screen for the service performed as referenced by Incident ID 48. There is only one incident illustrated in FIG. 4, however, there will typically be numerous incidents that are shown within the create service call report service screen 40. A button is provided to create service call report 47, via a button that is provided on the GUI 6 that will bring the pop up screen illustrated in FIG. 5. It will be understood by those skilled in the art, that variations of the pop up screen for create service call report 40 can be made and different indicators provided. A field that is specifically envisioned would be one for the date that a service was provided for the printer 5 referenced by Machine ID 46.

FIG. 5 illustrates the pop up screen referred to as create a service call 50 that is initiated as detailed above. The person responsible for making the service call report completes the fields within create a service call 50, which is then saved to the message log within the printer 5 and transmitted to the data collection server 1 at a later time. The fields will be filled in by the person responsible for servicing the piece of equipment, which in the preferred embodiment is a NexPress® 2100 that is a printer 5. The NexPress® 2100 allows operator maintenance for most servicing requirements, accordingly, an operator would be filling in the fields shown in FIG. 5. The SRC field identifies the action that takes place for any particular incident. The SRC number illustrated in FIG. 5 is a 4, indicating that the reason for servicing was to repair and maintain the printer 5, and the remedy was to adjust, align and setup the printer 5. The operator can fill in the fields with the corresponding data or actions. For instance, certain field headings such as those for Reason or Remedy, could be buttons presented by GUI 6 that allow the operator to activate a pull down menu containing a series of selections that the operator can choose. Other field headings would typically have values entered by the operator. It is specifically envisioned that the field headings can all be automated (such as activating a menu) or all be manual. The preferred embodiment would have the field headings for service hour and the quantity be manual and the remaining field headings would be automated to activate a menu upon selection. Once the pop up screen to create a service call 50 is completed, the operator activates the save 52 button which places the contents from the create a service call 50 pop up screen into the message log of printer 5 where it can later be transferred to the SDMS data repository 2.

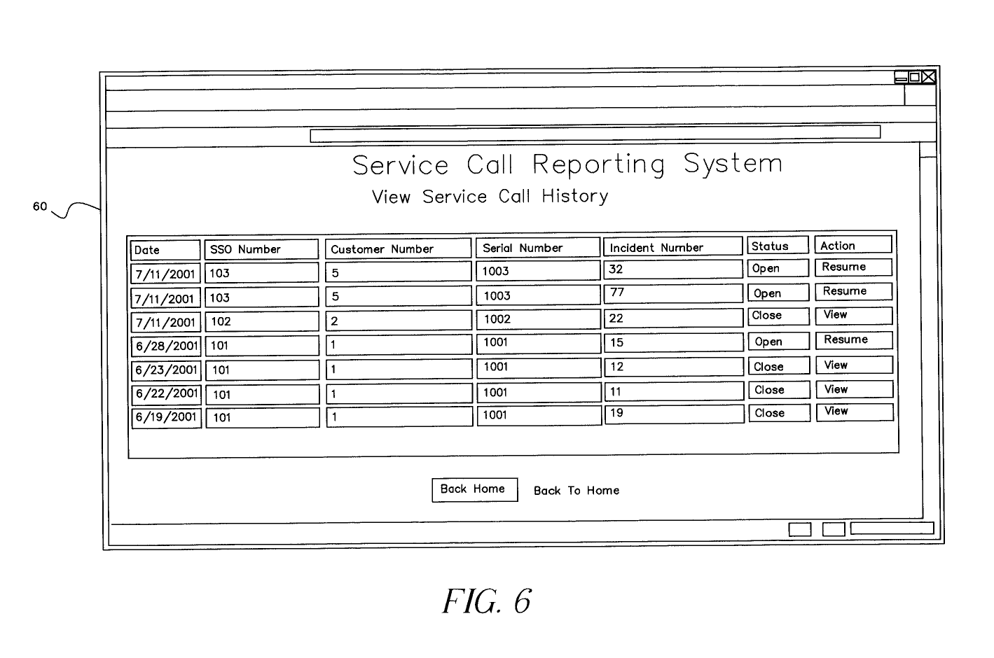

FIG. 6 illustrates a pop up screen for view service call history 60 that is displayed on the GUI 6 within the preferred embodiment to view the service calls that are stored in the SDMS data repository 2. The view service call history 60 is activated by a selection that is provided by the GUI 6. The preferred embodiment will store the view service call history 60 within each individual NexPress® 2100 and feed the service call history 80 to the SDMS data repository 2 at predetermined time periods.

The SDMS provides the following: collection, management, and reporting of service data; collection, management, and reporting of machine-generated data; collection, management, and reporting of job heuristics; basic service call management functions for the remote NexPress customer care center/customer service center; and ORC inventory management functions provided within the NexPress®2100.

The present invention envisions implementation of automated printing systems that will enable their service requirements including, tracking and reporting of service calls; service data collection; machine data collection; machine performance reporting; job heuristics data collection; and service performance reporting.

The invention makes numerous service assumptions that are believed to be valuable for all serviceable machines, but particularly for digital printers 5 as discussed herein. The primary business objective of service is to provide to the end customer maximum machine performance, maximum machine availability (“up-time”) and a low cost of ownership. In order to satisfy this primary business objective, the SDMS captures and reports service incident information and machine performance data. By capturing these types of information, the invention not only satisfies the primary service objective but also provides a means for continuous product design improvement, and to measure the achievement of both service and research, and development for the particular type of serviceable equipment for which it is employed.

Another objective of the SDMS 10 is to integrate data relating to service calls wherein the NexPress call center becomes involved with service calls. Typically the NexPress call center will become involved as a result from contacts initiated by Field Service engineers from the printer 5 or laptop computers that Field Service engineers use during service calls. All calls are logged into the NexPress call center and the data for each call is made available to the SDMS 10, preferably immediately, but variations of the availability of data are also envisioned. By integrating data from the NexPress call center with message log data contained on the printer 5, a complete chronology of all service call events and care center events for each machine is provided by the SDMS.

The SDMS 10 will retain service call data that is captured and stored by the NexPress® 2100. The time period that the SDMS will retain service call data is preferably for a period of 12 months, the rationale being that data older than 12 months is considered irrelevant. Other periods will also be desirable for a variety of reasons. The SDMS 10 can specifically set a time period to be short allowing witnessing of component wear and consumable usage resulting from uses of the printer 5 such as extended print runs using specific media or high color graphics concentration. Alternatively, the time period can be set to the life of the machine, allowing all events regarding a piece of equipment to be taken into account.

The invention employs the computational elements of the DFE in order to perform basic processing used by the SDMS 10. The design of the preferred embodiment currently includes capabilities to; capture and temporarily store machine settings at the time of error or failure, referred to herein as error events. Additionally, to capture and temporarily store machine settings as of predefined time intervals, referred to herein as time/date events. Further, to capture and temporarily store machine settings related to specific job processing, referred to herein as job events. Also, to capture and temporarily store machine settings at time of ORC replacement, referred to herein as operator events. Additionally, to capture and store for a one year period, machine settings at the time of ORC replacement, referred to herein as maintenance events. Lastly, to capture the temporary storage of service/repair information entered by field engineers. Service events will typically include the initial installation configuration of the machine, the capture and temporary storage of service call information entered by a field engineer; as well as the sending and receiving of data to and from a computational element external to the DFE. In the preferred embodiment, data sent to an external machine from the DFE will be compressed, encrypted, and password protected.

SDMS is preferably provided as a stand-alone application (Windows or Browser based) that is used in NexPress customer care/customer service centers. The NexPress® 2100 includes an internal 56K, or faster, telecommunications FAX capable modem that supports both dial-in and dial-out capabilities. The NexPress® 2100 printers 5 are network enabled and as envisioned form a network with printers 5.

The SDMS of the preferred embodiment uses error and resolution codes to eliminate multi-language reporting requirements from the system with the exception of free-text fields which will be translated on as-needed basis and outside SDMS 10. The SDMS 10 service call reporting tool will be developed as a stand-alone application (able to operate independently of the DFE) so that it may reside on a laptop of a field engineer as well as in the customer care center(s) to provide basic call tracking/reporting capabilities. Service call reports generated by customer care center and field engineers will be captured in the SDMS data repository 1 in similar fashion to those created by a field engineer at the customer site. The laptop for a field engineer and remote care center/remote service center computers operating the SDMS software will have a browser (Microsoft® Internet Explorer/Netscape®/etc.) and Adobe® Acrobat® Reader™ installed.

The previously described features allow the SDMS 10 of the present invention to provide “line of sight” visibility for installed machines; flexible reporting and ad-hoc analysis of machine service requirements and histories; flexible reporting and ad-hoc analysis of job heuristics; flexible reporting and ad-hoc analysis of ORC consumption for product engineers and marketing personnel; means to manage ORC inventories and to request ORC replenishment; an interim remote service center for service call tracking functions; analysis of actual machine performance to expected performance levels.

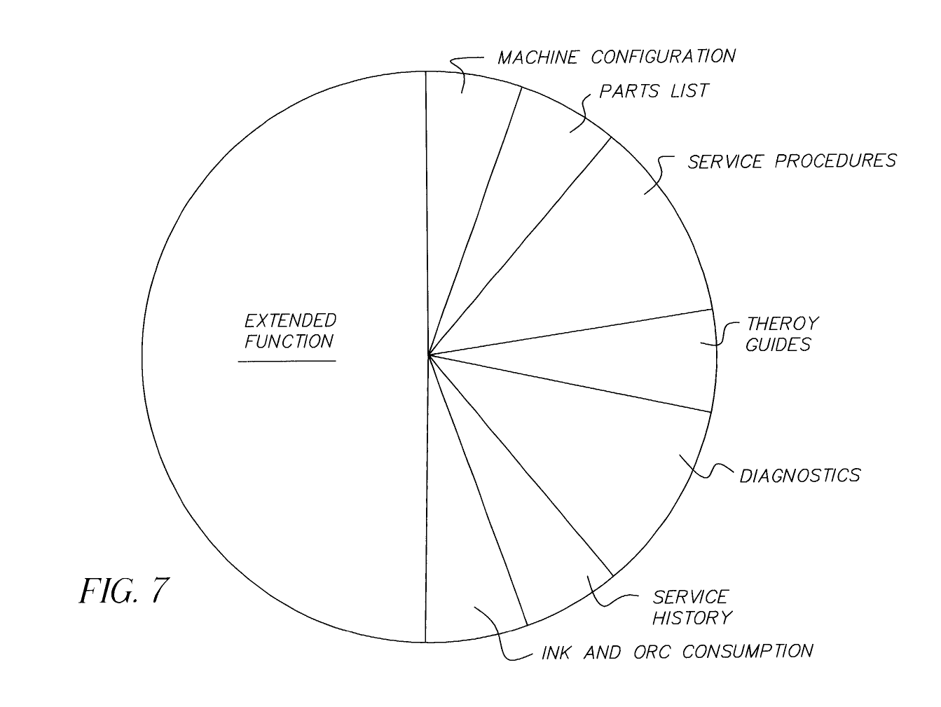

FIG. 7 illustrates functional elements contained within NexPert™, which is a proprietary software solution of NexPress Solutions, LLC. Included within NexPert™ are the elements required to run SDMS 10. The integration of the logs for tracking the functions shown in FIG. 7 is an important item within the SDMS 10. FIG. 7 illustrates the logged components in the form of a pie-chart, however, it should be understood that the actual log is stored as a table using conventional indexing features. The key elements of the SDMS as envisioned by the preferred embodiment are the machine's configuration, system diagnostics, service history, and ORC consumption.

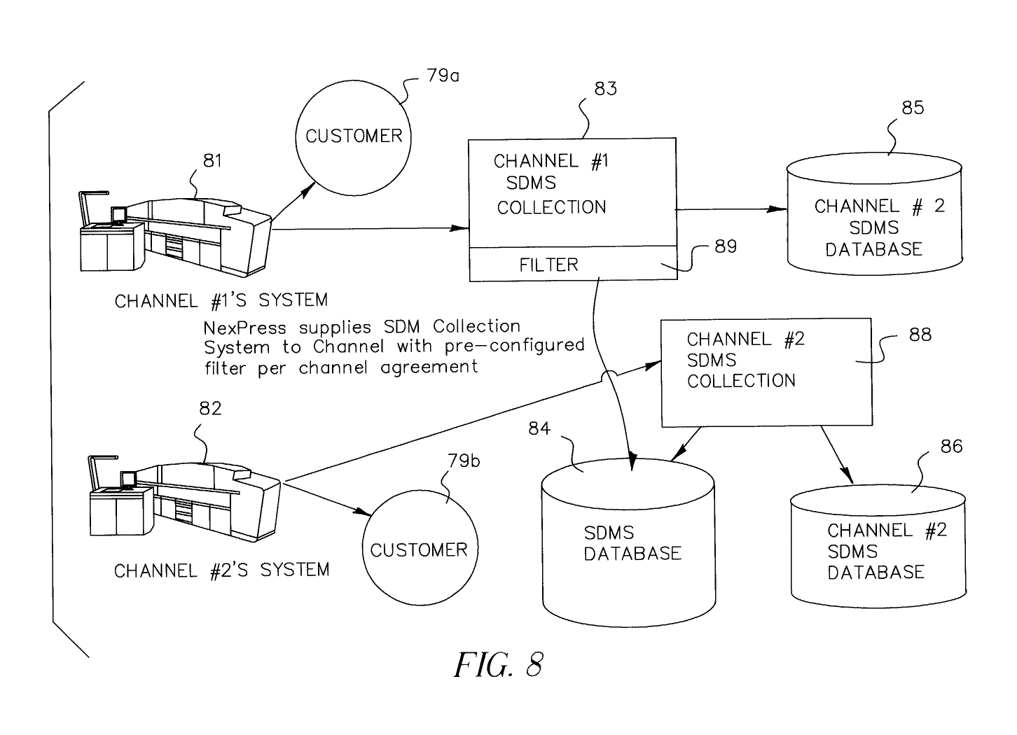

FIG. 8 is an illustration providing a high-level overview of the SDMS function to capture, store, and report the types of information shown in FIG. 7. As shown in FIG. 8, channel 1 and channel 2 systems 81, 82 have different configurations. Channel 1 system provides an interface to customer 79a that can provide a first set of data in accordance with a first set of parameters that are specifically designed by the user/operator of the channel 1 system. Channel 1 SDMS database 85 provides storage for the data to be archived from channel 1 SDMS collection 83. The channel 1 system 81 also provides an interface to a channel partner through channel 1 SDMS collection 83 that applies a filter 89 to the data from the channel 1 system. The filter 89 can be located at either the location of the channel 1 system 81 or more towards the SDMS database 84 that will retain the filtered data. The channel 2 system 82 illustrates a somewhat different configuration. The channel 2 system 82 will have a customer interface 79b, like that of the channel 1 system 81. The channel 2 system 82 also provides channel 2 SDMS collection 88, however, the channel 2 SDMS collection 88 does not have any filtering of the data to be collected. Parameters used in filtering collected data are envisioned as being applied in accordance with the terms of an agreement between the customer 79b (typically the user/operator) and a channel partner. The channel 2 system 82 has no filter applied, therefore, the SDMS database 84 will be able to store any types of data that can be tracked. The data placed on the channel 2 SDMS database 86 would then be substantially the same as that on the SDMS database 84.

Referring again to FIG. 1, the SDMS 10 of the invention envisions several components, such as the SDMS data repository 2 that can be accessed by numerous methods. FIG. 1 illustrates various possible methods of information flow from the NexPress® 2100 digital printer 5 to the SDMS data repository 2. These methods of information flow are discussed below in order preference. It should be understood that communication constraints exist for certain owners/operators of the digital printers 5, whereas other owner/operators will have dedicated Internet access.

In the first method, as illustrated in FIG. 1, an Internet connection to the SDMS data repository 2 is provided via a non-persistent connection 22 to transfer information. Data is transmitted from a digital printer 5 through the non-persistent connection 22 via the Internet to an external data server, which in the preferred embodiment is the data collection server 1. It should be understood that numerous configurations for interfacing to an external server are possible and that the configuration of the data collection server 1 is only one of many possible configurations. The data collection server 1 functions to collect data from Internet connected systems, validate it, filter it (if needed), and transfer it back to the SDMS data repository 2. Information collected on the data collection server 1 is passed at frequent intervals to the SDMS data repository 2, however it does not have a dedicated connection through the firewall. While the connection from the owner/operator is shown as occasional, as indicated by the dotted line, it should be readily understood that an owner/operator can have direct, dedicated Internet connectivity and that it is not necessary to modify this design to accommodate dedicated connectivity. If the owner/operator chooses to use FTP to transfer data, they must assure that an Internet connection is present before starting the transfer. Owners/operators who do not have a dedicated connection to the Internet should be advised to utilize email as their communication method. It should also be noted that data from the digital printer 5 is illustrated flowing directly to the channel partner and that the channel partner can receive variable sets of information. The channel partners can receive all information that can possibly be provided by digital printer 5, or the channel partners can receive subsets of information that is determined by filters placed on the connection between digital printer 5 and the external server. Additionally, multiple channel partners can receive the same information as transmitted from the digital printers 5, or filters can be applied to provide only desired subsets of data to different channel partners.

A second method illustrated in FIG. 1 is the use of a leased network to transfer information. In this scenario, a leased network between the digital printer 5, and the SDMS data repository 2 allows the owners/operators to interface the digital printer 5 via a telephone number and a modem, preferably an internal modem of the digital printer 5, that is connected to a leased network. Data is transferred using FTP to a data collection server 1 that resides on the network directly attached to the leased network. Once the data is placed on the data collection server 1, it is validated and passed on to the SDMS data repository 2. As in the previous example, filters can be applied at any of the foregoing points to provide predetermined subsets of data. Also, numerous modifications to the firewalls and servers as shown in FIG. 1 can be employed as will be readily apparent to those skilled in the relevant arts. Preferably, the data collection server 1 resides outside of the first firewall 11 to prevent the transfer of data directly to the SDMS data repository 2. The preferred embodiment envisions that the data on the data collection server 1 will be subject to a process that will validate the data, filter it (if needed) and package it for transmittal to the SDMS data repository 2. If the connection to the repository is not dedicated, it is recommended that it be handled as a periodic transaction for security.

In a third method, a field engineer laptop 32 will provide an option on the screen for creating a service call report 40 which will copy a subset of the data that is normally transmitted to data collection server 1 to the field engineer laptop 32. The subset of data can then be forwarded via email or FTP to a data collection server 1, where it will be validated, filtered (if needed) and packaged for transmittal to the SDMS data repository 2.

Still another method of information retrieval facilitates special situations that may occur where no communication is possible with the owners/operators digital printers. This situation can occur when a field engineer is at the customer location handling a repair, at which point, a subset of data can be printed with their screen for creating a service call report 60. The field engineer then sends these pages for the screen for creating a service call report 60 to NexPress® via either internal mail or postal service. Once the data arrives at NexPress®, a system administrator enters it manually into the SDMS data repository 2.

Once the data is located in the SDMS data repository 2, it can be disseminated in any of several ways. The preferred embodiment employs two ways for the dissemination of data stored in the SDMS data repository 2. The first way is through a World Wide Web (WWW) based reports server 3 operated by a channel partner, such as the reports server 3 located on the NexPress® intranet as shown in FIG. 1. The reports server 3, within the preferred embodiment, will support both stored and user-defined reports (user-defined reports, such as those referred to herein as crystal reports, may require creation of separate fields such as number of reports, days in which reports were made, and machines serviced), which access data directly from the SDMS data repository 2. The reports server 3 will also allow the automated running of a report, which may then be distributed by email to a list of recipients. Additionally, the reports server 3 will also allow the output of the report in various forms, which must include Microsoft® Excel, Comma Delimited Format, HTML, and PDF and may include others. Users can access data on the reports server 3, by using an Internet-based browser (such as Netscape® or Microsoft® Internet Explorer) through the intranet.

The second dissemination method used by the preferred embodiment, is to extract a subset of data to a repository on an external data server (not shown) that may be accessed by a channel partner in various ways, including reporting as well as direct extraction of data. The data on the external data server, typically, will be read-only and no data will flow from the data repository on an external data server back to the SDMS data repository 2.

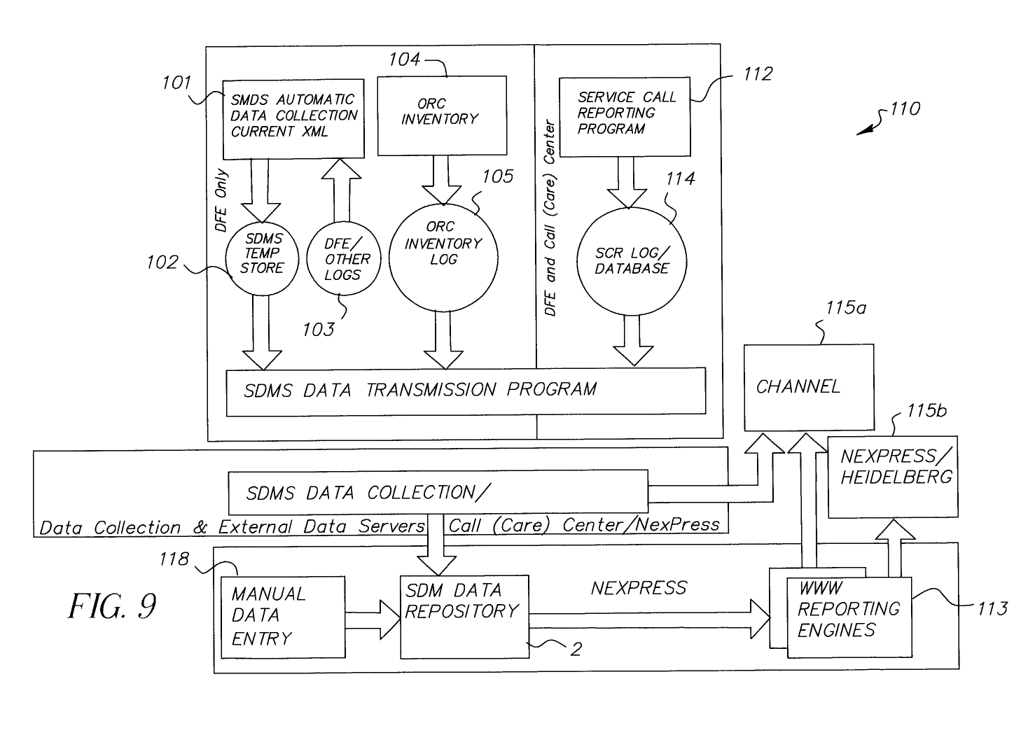

Referring to FIG. 9, which is a diagram for the data flow for the SDMS 10 of the present invention shown in perspective with the SDMS data repository 2, the logical data flow within FIG. 9 identifies the key application components or “subsystems” of SDMS 10, their relationships to one another, and the environment in which they exist. The logical data flow within FIG. 9 also illustrates the flow of data in and out of the system. More specifically, the SDMS data transmission program 106 will receive data related to the ORC inventory 104 from the ORC inventory log 105 of the DFE and compresses and encrypts the ORC data before sending it to the SDMS data collection 108. The SDMS data collection 108 contains the SDMS data collection server 1 as well as verification programs and possibly other servers external to the digital printer 5. The SDMS data transmission program 106 will receive data related to the SCR log database 114 which is a log created from service call reporting program 112 in the call care center. The SDMS data transmission program 106 will receive data related to the SDMS automatic data collection 101 which contains the previously discussed SDMS data as well as DFE/Other logs via the SDMS temporary storage 103 and compresses and encrypts the SDMS data prior to transmission to the SDMS data collection 108. The SDMS data collection 108 provides an integration point for all of the above reference data. From the SDMS data collection 108, data can then be routed directly to a channel 115 that can be accessed by either an owner/operator or a channel partner depending on the configuration of the system. The preferred embodiment will have the SDMS data repository 2 receive data from the SDMS data collection 108 as well as any manual data entry 118 that may have taken place. WWW reporting engines 113 provides data to the reports server 3 and other external databases that be accessed via either channel 115 or though channel partners 114 such as NexPress/Heidelberg using an Internet-based web browser as previously discussed. Filters can be applied at anyplace along the SDMS logical data flow 110 as previously discussed, to provide data in accordance with predetermined parameters. The SDMS logical data flow 110 can have any of a number of configurations as will be readily apparent to those skilled in the art, the above discussed embodiment represents the best mode known to the inventors.

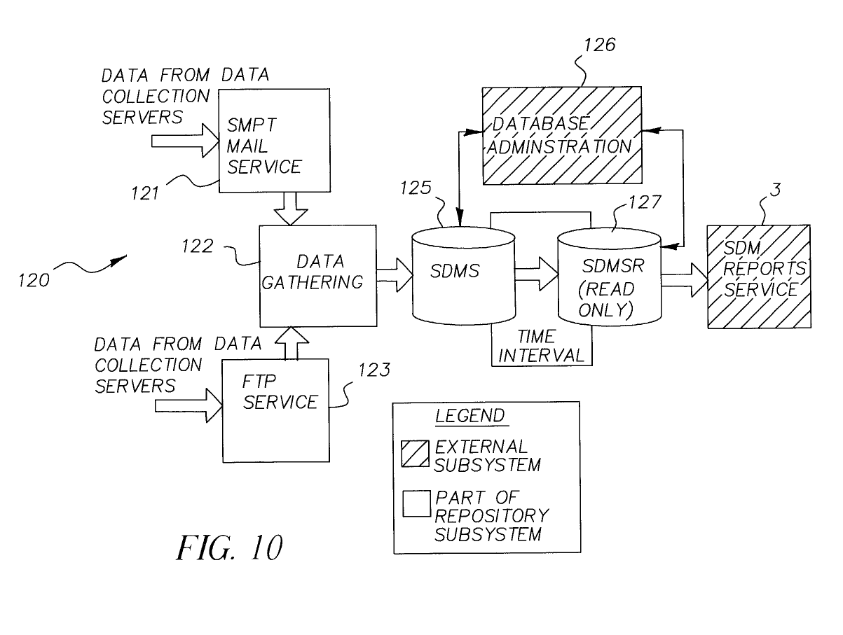

Referring to FIG. 10, which is a diagram illustrating the data repository architecture 120 for the previously discussed SDMS data repository 35. The data repository architecture 120 identifies the key data stores (data bases, and data files), their relationship to one another, and how the data flows through the system area related to the SDMS data repository 35. Data gathering 122 provides for decompression, de-encryption and cleaning services (cleaning service including but not limited to the removal of garbage data or purging data after a predetermined period of time) for data that is received from data collection servers via the SMTP mail service 121 and the FTP services 123. The SDMS database 125 will receive data that has been operated on by the data gathering 122. The database administration 126 will control both SDMS database 125 and the read only SDMSR 127 to provide the final data available through the SDMS reports service 3.

It is significant, although not critical to the invention, that no interfaces to other systems (other than those which are already a part of the user interface and the operating system to digital printer 5) are defined as requirements for the SDMS. “Interfaces,” or more accurately named “Integration Points” will exist within both the user interface UI and the operating system for the purpose of seamless integration to the end-user and for the sake of sharing common data structures such as failure codes, service response codes, etc.

The communication of the SDMS 10 encompasses the transmission of data from the NexPress® 2100 digital printers 5 in the field and multiple call centers to the SDMS data repository 2 located on the NexPress® network. Several methods of communication are possible with a system like the SDMS 10, those most preferred will be explained below, however, it should be understood that the most preferred embodiments are related to digital printers and the invention as a whole relates to serviceable equipment. The Internet remains the preferred method of transport, but an option for a leased network and Field Engineer (FE) collection allows owners/operators who have no Internet access to be able to employ the features of the invention. Wireless technology (including cellular and satellite) is envisioned as a viable form of communication for the invention. Point to point direct connection from a customer system to a NexPress® system (whether or not the customer, or NexPress® initiates the call).

Using SMTP, it is envisioned that data will be transmitted from the printer 5 by email using the Internet as the network layer. The data transmission program within the DFE for a NexPress® 2100 formats the data into an SMTP compliant email and forwards it to the customer's SMTP mail server. The message will then wait until the SMTP server has a connection to the Internet, whereupon it will transmit the message to the SDMS external data server. The external data server will then, at some specified interval, pass the email through the NexPress® firewall to the SDMS data repository 2, where the data will be reconstructed and added to the repository. This method requires that the digital printer 5 have an SMTP mail server on a network if there is no direct connection to the Internet, and Internet connectivity to the SMTP mail server. In the case of the preferred embodiment, the DFE for a NexPress® 2100 will be able to pass email messages to the SMTP mail server. The preferred embodiment also envisions the use of a data server outside a firewall to receive SMTP email messages so that the external server is able to pass email through the firewall to the SDMS data repository 2. The specific arrangement of firewalls and servers can be changed or even left out entirely in alternative embodiments.

Using FTP over the Internet, the data is sent directly to an external data server. The data transmission program on the DFE generates a data file and compresses and encrypts the data for transfer. It then sends the file using the FTP program (through a proxy server if required in the customer's network) to the external data server. The external data server examines the file for validity and, at some specified interval, transmits the data file to the SDMS data repository 2 where the data is manipulated and added to the data store. The method of using FTP over the Internet typically would require that the digital printer 5 be operatively connected to a direct, ubiquitous Internet connection. Preferably, the digital printer 5 is a NexPress® 2100 having connectivity such that the DFE is capable of transmitting FTP traffic outside any internal network to an external data server. The invention envisions that a server inside a firewall is accessible from an IP address outside the firewall to receive FTP data from the DFE. The external data server is envisioned as having the capability to send data through the firewall to the SDMS repository (although this need not be done via FTP). In the preferred embodiment, a hole is punched through the firewall to allow access by the external server. The SDMS repository must have service running to receive the data.

Embodiments using a leased network rather than the Internet as a communication medium would typically require a modem within the digital printer 5. In the case of a NexPress® 2100 being used as a digital printer 5, an internal modem would be installed on the DFE to transfer the data. The data transmission program creates a data file that is then compressed and encrypted. The program then initiates a call using the modem to connect to the leased network. Once the connection is made, the program uses FTP to transmit the data to the data collection server 1 on the private network. The data collection server 1 examines the data, and then transmits the data over a second network connection tied to the SDMS data repository 2. The local dial-up connection is then terminated.

Typically using a NexPress® 2100 as the digital printer 5, the dial-up connection described above, the DFE internal modem will be connected to a live telephone line which is generally available for outside calls. A leased network is available and attached to a private network. A phone number for the leased network is configured in the SDMS. A server is required for the FTP service on a private network to receive the FTP connection and the DFE (or other such computer based area) needs to use FTP to transmit data to the server on the private network. If on a private network, the server must be able to forward the data to the SDMS Repository via an intranet among at least one company. The SDMS data repository 2 needs to have service for the FTP.

The foregoing description has detailed the embodiments most preferred by the inventors, variations of these preferred embodiments will be readily apparent to those skilled in the relevant arts, therefore, the scope of the invention should be measured by the appended claims.

Parts List

1 data collection server

2 data repository

3 reports server

5 printer(s)

10 SDMS

11 first firewall

12 Internet connection

13 firewall

15 external server

22 non-persistent connection

25 data

32 field engineer laptop

35 data repository

40 screen for creating a service call report

42 Sales Service Unit

44 Customer ID

46 Machine ID

48 Incident ID

47 create a service call report button

50 screen for configuring data transmission

51 File Transfer Protocol (FTP)

52 Simple Mail Transfer Protocol (SMTP)

60 service call history

79a customer

79b customer

80 service call history

81 channel 1 system

82 channel 2 system

83 channel 1 SDMS collection

84 SDMS database

85 channel 1 SDMS database

86 channel 2 SDMS database

88 channel 2 SDMS collection

89 filter

101 SDMS automatic data collection

103 SDMS temporary storage

104 ORC inventory

105 ORC inventory log

106 data transmission program

108 SDMS data collection

110 logical data flow

112 service call reporting program

113 reporting engines

114 SCR log database

115 channel

118 manual data entry

120 data repository architecture

121 SMTP mail service

122 data gathering

123 FTP services

125 database

127 SDMSR

What is claimed is:

1. A system for integrating information related to equipment operation comprising:
at least one piece of equipment located at least at a first location;
a data repository at a second location remote from said first location;
an interface between said piece of equipment and said data repository allowing data from said piece of equipment to be collected and stored at said data repository;
a filtering mechanism for applying at least one predetermined parameter to data on said interface to create a filtered data set; and
wherein said filtered data set represents data collected from said machines for at least service history and types of use of said machines.

2. The system for integrating information of claim 1, wherein said filtering mechanism is located at said data repository.

3. The system for integrating information of claim 1, wherein said filtering mechanism is located at said piece of equipment.

4. The system for integrating information of claim 1, wherein said piece of equipment is a reprographic device having a plurality of serviceable components and said filtering mechanism further comprises data relating to deviations from a predetermined norm for said pieces of equipment.

5. The system for integrating information of claim 4, wherein said filtered data set contains data relative to said serviceable components.

6. The system for integrating information of claim 5, wherein said pieces of equipment each contain a log of information relative to the use of said piece of equipment.

7. The system for integrating information of claim 1, wherein said communication interface to said piece of equipment further comprises at least one Internet protocol transferring said filtered data set linking reports to said pieces of equipment.

8. The system for integrating information of claim 1, wherein use data within said filtered data set further comprises data relative to media types used by said piece of equipment.

9. The system for integrating information of claim 1, wherein said piece of equipment at said first location is operated by a first business entity and said data repository at said second location is operated by a second business entity that is higher in the supply chain for said piece of equipment than said first business entity.

10. The system for integrating information of claim 1, wherein said piece of equipment at said first location is operated a first business entity and said data repository is operated by a plurality of second business entities that are higher in the supply chain for said piece of equipment than said first business entity and wherein said second location comprises at least one data repository location.

11. The system for integrating information of claim 1, wherein said piece of equipment at said first location and said data repository at said second location is operated by the same business entity.

12. The system for integrating information of claim 9, wherein said filtering mechanism further comprises a first filter at said first location that said first corporate entity applies to data from said piece of equipment that is sent to said data repository.

13. The system for integrating information of claim 12, wherein said filtering mechanism further comprises a second filter at said second location that said second corporate entity applies to a filtered data set from said piece of equipment that is sent to said data repository.

14. The system for integrating information of claim 9, wherein said filtering mechanism further comprises a discretionary filter at said second location that is applied to data sent to said data repository.

15. The system for integrating information of claim 14, wherein said discretionary filter further comprises a first set of data that is sent to said first business entity and a second set of data that is retained by said second business entity.

16. The system for integrating information of claim 14, wherein said discretionary filter is applied to data sent to said data repository to create a portion of the data that is used by another business entity higher in the supply chain than said first corporate entity.

17. A system compromising:
at least one piece of electronic equipment having a log of tracked information, said piece of equipment being located at a first location and said log of tracked information containing data related to types of use for said piece of equipment and service data for said piece of equipment;
a storage repository located at a second site remote from said first site, said storage repository being used to store said log of tracked information; and
an extraction mechanism contained on said piece of electronic equipment to extract said log information and electronically transfer it to said second site.

18. The system of claim 17, wherein said piece of electronic equipment further comprises a user interface that allows configuring said remote site to which said log information is sent.

19. The system of claim 17, wherein said piece of electronic equipment further comprises a filter for said log of tracked information, said filter providing for filtering of content being sent to said remote site.

20. The system of claim 17, wherein said extraction mechanism further comprises a transfer mechanism to extract said log information on a periodic time interval.

21. The system of claim 17, wherein said piece of equipment further comprises a printing system with a variety of components that wear with use of said printing system and said log of tracked information further comprises tracked information regarding said variety of components.

22. The system of claim 21, wherein said log of tracked information further comprises data relative to the use of said printing system.

23. The system of claim 21, wherein said log of tracked information further comprises data relative to components that have been replaced or consumed within said printing system.

24. The system of claim 21, wherein said log of tracked information further comprises a number of sheets and a type of paper printed on said printing system.

25. The system of claim 21, wherein said extraction mechanism can perform internal diagnostics and report diagnostic findings in said log of tracked information.

26. A method of accumulating data related to serviceable pieces of equipment compromising the steps of:
providing at least one serviceable piece of equipment having a log of tracked information relating to the use of said piece of equipment and service data for said piece of equipment;
first filtering of said log information with a first set of predetermined set of parameters;
sending of said log information to an intermediate site; and
second filtering of said log information and sending to a centralized site.

27. The method of claim 26, wherein the step of sending further comprises sending said log information to said intermediate site that has a user interface which can configure said central site to which said log of information is sent.

28. The method of claim 26, wherein the step of second filtering further comprises said centralized site taking said log of information and populating a database management system with content from said log of tracked information.

29. The method of claim 26, wherein the step of second filtering further comprises generating reports from data captured and recorded in said log of information.

30. The method of claim 29, wherein the step of generating reports further comprises the step of allowing the reports to be electronically available to users distributed throughout the world.

31. The method of claim 29, wherein the step of generating further comprises the step of creating field service reports and call reporting service reports.

32. The method of claim 31, wherein the step of generating further comprises the integrating call service reports and field service reports.
